(19) United States
(12) Patent Application Publication
(10) Pub. No.: US 2024/0126611 A1
(43) Pub. Date: Apr. 18, 2024

(54) Workload-Aware Hardware Architecture Recommendations

(71) Applicant: Microsoft Technology Licensing, LLC, Redmond, WA (US)

(72) Inventors: Amar PHANISHAYEE, Seattle, WA (US); Divya MAHAJAN, Seattle, WA (US); Janardhan KULKARNI, Redmond, WA (US); Miguel CASTRO, Cambridge (GB); Muhammad ADNAN, Vancouver (CA)

(73) Assignee: Microsoft Technology Licensing, LLC, Redmond, WA (US)

(21) Appl. No.: 17/965,681

(22) Filed: Oct. 13, 2022

(51) Int. Cl. G06F 9/50; G06F 9/48; G06N 3/08

(52) U.S. Cl. CPC G06F 9/5044; G06F 9/4881; G06F 9/505; G06N 3/08

(57) ABSTRACT

The description relates to accelerator architectures for deep learning models. One example can obtain a deep learning training script associated with a deep learning model and extract an operator graph from the training script. The example can split the operator graph into first and second portions of a heterogeneous pipeline and tune a first accelerator core for the first portion of the heterogeneous pipeline and a second accelerator core for the second portion of the heterogeneous pipeline. The example can also generate a hardware architecture that includes the first accelerator core and the second accelerator core arranged to collectively accomplish the deep learning model.

### BACKGROUND

Deep learning is being used to accomplish an ever-increasing array of tasks, such as, facial recognition, speech recognition, language translation, etc. Deep learning models are continually being developed to accomplish individual tasks. However, performance of individual deep learning models is constrained by the computer hardware upon which they run.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1, 2, and 7 show example systems in which the present concepts can be applied in some implementations.

FIG. 3 shows an example architectural template that is consistent with some implementations of the present concepts.

FIG. 4 shows an example operator graph that is consistent with some implementations of the present concepts.

FIGS. 5 and 6 show example flowcharts for accomplishing workload-aware hardware architecture recommendation concepts in accordance with some implementations.

### DETAILED DESCRIPTION

This patent relates to hardware architectures to be employed to accomplish various deep learning workloads. Deep learning is increasingly relied upon to accomplish a wide array of computing tasks. However, deep learning models do not lend themselves to traditional central processing units (CPUs) because CPUs are general purpose. These cores tend to operate in a serial manner. Instead, deep learning models tends to run more efficiently on domain-specific accelerators. Specialized cores employed in domain-specific accelerators target specific processing needs. For instance, graphics processing units (GPUs) employ many simpler cores to handle processing in a more parallel manner. Other processors, such as application specific integrated circuits (ASICs), coarse grain reconfigurable architecture (CGRAs), and field programmable gate arrays (FPGAs), have been utilized to accelerate deep learning workloads. Tensor cores were developed and/or enhanced to execute array processing and vector cores were developed to execute vector processing. (In this document the term domain-specific accelerator may be shortened to ‘accelerator’ for sake of brevity.)

Each of these domain-specific accelerators may offer advantages for processing some types of deep learning models. However, different deep learning models continue to be developed. Further, deep learning models are getting larger and more complex. Thus, a single accelerator and/or a single accelerator type may not effectively perform a desired deep learning model. Instead, multiple accelerators of one or more accelerator core types may be combined to achieve the desired metric of interest. However, there is a limit to how many cores and supporting components can be positioned on a given chip. The present concepts provide automated solutions for recommending or selecting a hardware architecture that defines a domain-specific accelerator for accomplishing one or more deep learning models. The hardware architecture can relate to the core type or types and the number of each core type on the chip. The hardware architecture can be selected to enhance/optimize performance of a set of one or more deep learning models.

As introduced above, domain-specific accelerators have become mainstream for deep learning with deployments in both datacenters and mobile platforms. Existing design space exploration tools are either limited to a single accelerator, only inference, or tuning the architecture for specific layers (e.g., convolution layers). The present concepts include workload-aware hardware architecture mining (WHAM), which provides a framework to perform a multi-dimensional exploration of both the domain-specific accelerator architecture and its operator schedule for training a deep learning workload. These solutions can optimize for the end-to-end metric of throughput/thermal design power (TDP) for training with fixed area and power constraints. From another perspective, WHAM offers a general approach to perform a combined exploration of domain-specific accelerator architecture, find an execution schedule on the domain-specific accelerator, utilize compiler optimizations on deep learning (DL) graphs, and generate efficient parallelization schemes for training DL models.

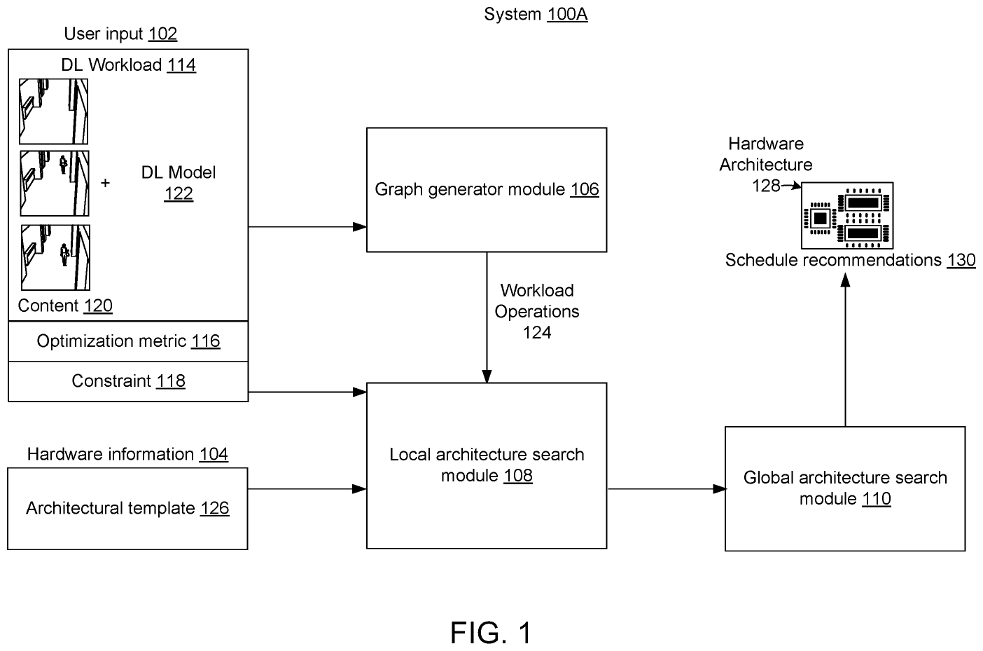

Furthermore, WHAM caters to the recent trend of large language models that mandate distributed pipeline-parallel training across multiple domain-specific accelerators. WHAM enables heterogeneous pipelines by tuning the hardware architectures for different sections of the model within the pipeline and thereby optimizes end-to-end throughput. WHAM has been evaluated against multiple different deep neural network (DNN) models, across three different tasks (image classification, translation, and language modeling). Compared to prior work, averaged across the evaluated workloads, WHAM optimized single accelerator designs improve performance and throughput by up to 35× when tuned for individual workloads and by up to 9× when tuned in unison for all the workloads. For distributed training, WHAM's heterogeneous domain-specific accelerators offer on average 22.5× higher Perf/TDP over homogeneous baseline architectures in a pipeline. These and other aspects are described in more detail below relative to FIG. 1.

FIG. 1 shows an example WHAM system 100A that can implement the present workload-aware hardware architecture mining concepts. The WHAM system 100A includes user input 102, hardware information 104, a graph generator module 106, a local architecture search module 108, and a global architecture search module 110.

The user input 102 includes a DL workload 114, optimization metrics 116, and constraints 118. The DL workload 114 can include content 120 and a deep learning model 122. In the illustrated example, the content 120 includes video frames and the DL model 122 which is configured to identify objects of interest (e.g., people) in the video frames. As mentioned above, other DL models perform other functions. The optimization metrics 116 can include various aspects, such as throughput or efficiency (e.g., computations per watt). The constraints 118 can include latency, power consumption, etc.

The user input 102 is fed to the graph generator module 106 and the local architecture search module 108. The graph generator module 106 can generate a graph of workload operations 124 that the DL model 122 employs to accomplish the function. The graph can provide information about the inter-relationships of the operations. This information can be leveraged to decide what parts of the graph to perform together as groups (e.g., single accelerator or heterogeneous pipeline of accelerators).

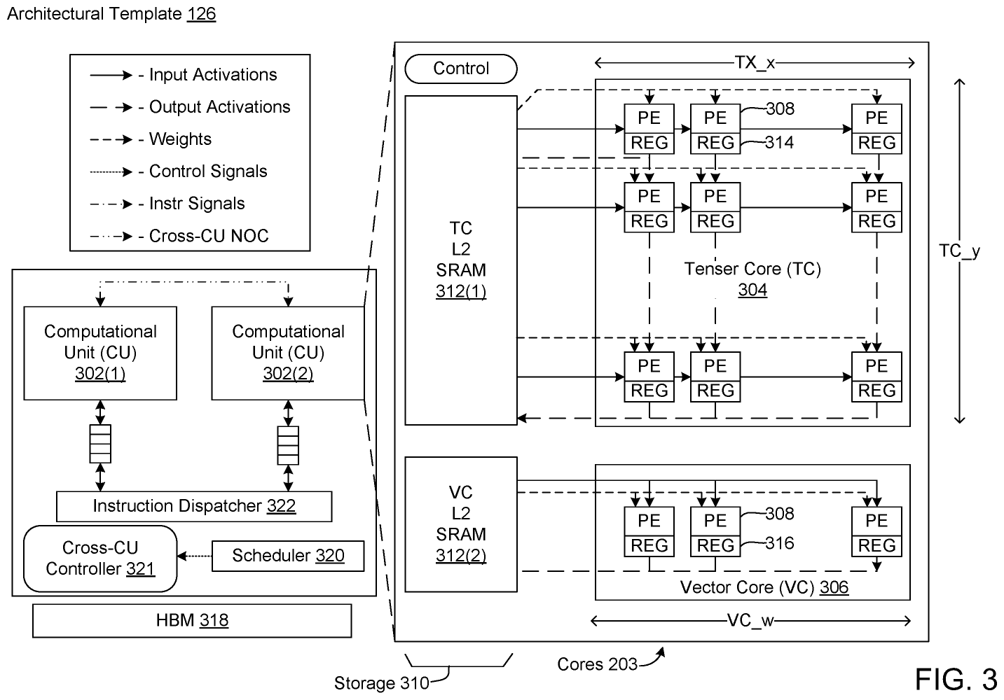

The hardware information 104 can include architectural template 126. The architectural template 126 can include computational units of various domain-specific accelerator core types, such as tensor cores and/or vector cores, as well as other chip information, such as memory, core dimensions, and/or chip dimensions, among others. An example architectural template 126 is illustrated and described below relative to FIG. 3.

The local architecture search module 108 receives the graph of workload operations 124 and the hardware information 104. The local hardware architecture search module 108 can evaluate individual core types from the architectural template 126 for accomplishing a portion or sub-set of the workload operations (e.g., heterogeneous pipeline sections). For example, the local hardware architecture search module 108 can compare the performance, such as throughput (e.g., completion time), power consumption, latency, etc. for the portion of the workload operations 124 on each of the accelerator(s) provided by the architectural template 126. For instance, if the portion of the workload operators include large numbers of matrices, the local hardware architecture search module 108 may rank tensor core type accelerators higher than other accelerator types. Similarly, if another portion of the workload operators include vector operations, the local hardware architecture search module 108 may rank vector core type accelerators higher than other accelerator types for this portion.

The global architecture search module 110 can receive performance information from the local architecture search module 108. The global architecture search module 110 can identify and rank hardware architectures (e.g., domain-specific accelerator architectures) derived from the architectural template that include core types (and their respective ratios) to accomplish the workload. The highest-ranking hardware architectures can be presented as recommended hardware architectures 128. The recommended hardware architectures 128 can include the accelerator types and their respective numbers, as well as other hardware information, such as the amount of memory, etc. Thus, the recommended hardware architectures 128 can include one or more accelerators and the type and number of cores of the accelerator(s).

The global architecture search module 110 can find recommended hardware architectures 128 and their corresponding schedule recommendations 130 for every accelerator in a pipelined distributed training-based execution. Thus, the present implementations perform architecture search using a critical-path based approach. Existing technologies perform an exhaustive search and attempt to select the best existing accelerator. In contrast the present implementations perform a deliberate critical-path based approach for architecture and scheduling search.

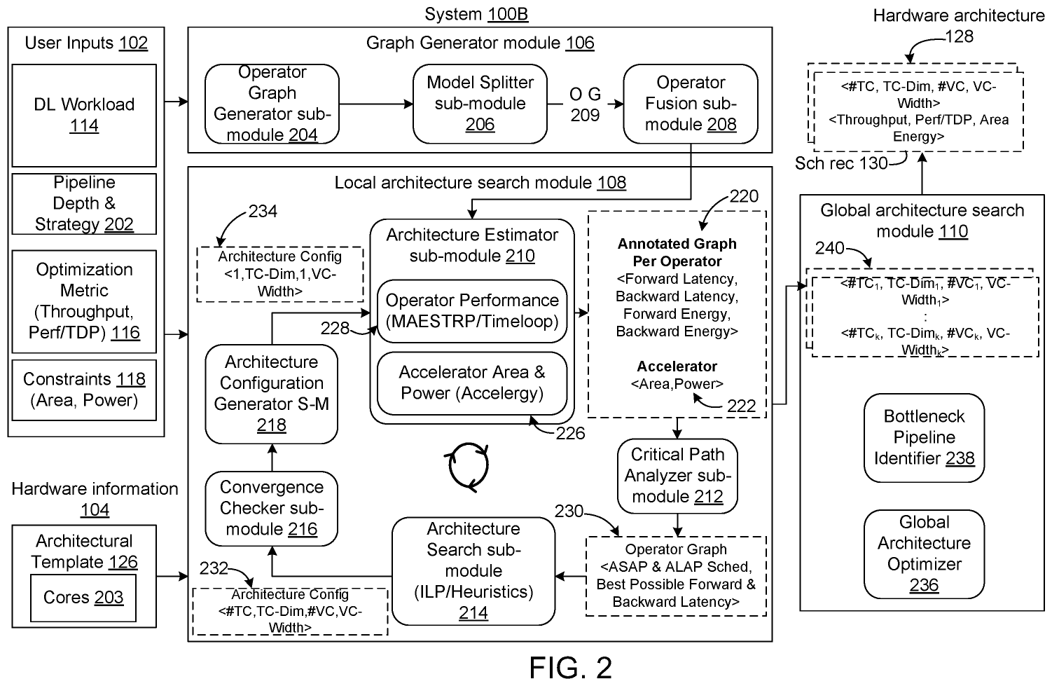

The present implementations perform both local architecture search (for single accelerator training) and global architecture search (distributed pipeline parallel training). The local architecture search can determine homogeneous design (same architecture) for a set of workloads. ASICs are suitable for homogeneity. The local architecture search can also determine heterogeneous tailored designs for every workload. In relation to global architecture search, traditional techniques only focus on a single accelerator. The present concepts exploit the observation that when a DNN model is spread across multiple accelerators for pipeline parallel training, each stage of the pipeline might not need the highest performing architecture. Instead, the stage may achieve the same results using an architecture from the top-k to optimize the end-to-end energy efficiency of the pipeline. These aspects are described in more detail relative to FIG. 2.

As mentioned above, deep learning is a continuously evolving space with innovations in both deep learning models and hardware architectures. Newer hardware architectures supersede past designs to cater to newer deep learning models. However, going through the entire cycle of redesigning hardware architectures is time consuming. An example case in point is the evolution of a well-established deep learning tensor core accelerator (e.g., tensor processing unit (TPU)). TPUv1 had a single 256×256 systolic array in a chip, while TPUv2 reduced the systolic array size to 128×128 with two systolic arrays, and TPUv3 is a dual core chip with each core having two 128×128 systolic arrays. Systolic arrays entail a lattice of synchronous and locally connected processing engines.

Large systolic arrays provide more compute per byte of high bandwidth memory but are inefficient as most deep learning workloads do not fully utilize the 256×256 systolic array. Such accelerator evolution raises a fundamental question or problem regarding the correct number of cores and respective size of each core for training deep learning workloads. The present concepts address the technical problem in a broader context. The present implementations provide a technical solution to co-optimize the architecture of a distributed pipeline of accelerators and their corresponding runtime DL-operator schedule to enable distributed training of large deep learning models.

Specifically, the present WHAM implementations can answer multiple technical problems relating to DL workloads. One technical problem relates to tuning a single accelerator. For a given workload that trains on a single accelerator, the present WHAM implementations can tune the architecture to optimize for end-to-end training throughput. Specifically, WHAM's technical solution can determine the type of cores to employ, such as tensor and vector cores, optimal number of each core type, the dimensionality of each of these cores, and the size of the on-chip buffers, for training a DNN under pre-specified area and power constraints.

The second technical problem relates to determining operator scheduling. Given the compiler optimizations that efficiently use the on-chip memory and reduce data movement, WHAM's technical solution can co-optimize the scheduling of the DNN operator graph with the hardware architecture across the entire training pipeline.

The third technical problem relates to tuning multiple accelerators. For pipeline-parallel training across multiple accelerators, WHAM's technical solution can determine what are the heterogeneous designs obtained by tuning individual accelerators (each executing a part of the model) to achieve higher energy efficiency.

The next technical problem relates to local versus global search. While optimizing for end-to-end pipeline throughput, instead of an independent local search on each accelerator (based on what it executes), WHAM's technical solution can determine what are the benefits of both a local search and a global search that tunes all accelerators with an eye towards efficiency (Perf/TDP).

Searching through a multi-dimensional space of general architecture configurations, schedules for operator execution, especially for large training operator graphs in the face of compiler optimizations and distributed execution across multiple accelerators, is computationally challenging. WHAM uses three key insights to address this challenge. First, WHAM leverages the insight that accelerator vendors have converged on offering specialized cores, such as tensor and vector cores with high-bandwidth memory (HBM), that serve a wide range of common DNN operators.

Tensor cores execute matrix multiplication-based operations, whereas the vector cores execute activation and element wise operators. In WHAM, each operator in the DNN graph executes on a single computation core. Consequently, WHAM uses a tunable architectural template that defines the scope of its design space exploration. This tunable architectural template entails computational units that can have tensor and vector cores (either one of them or both), among others. The technical problem of tuning the hardware architecture for a workload boils down to determining the number of each core type, such as tensor and vector cores, their dimensionality, and on-chip buffer sizes. This technical solution can be output as a recommended hardware architecture.

Second, instead of searching through the space of all possible architectural configurations and selecting the best from the options, WHAM leverages critical path analysis to determine the number and dimensionality of compute cores that need to be added based on the requirements of a deep learning direct acyclic graph (DAG). Additionally, the present implementations offer a novel Integer Linear Programming (ILP) formulation that can tune the architecture and determine the corresponding schedule for operator execution given area and power constraints. While the ILP provides optimality guarantees, it is computationally expensive and its solving time scales poorly with large operator graphs.

Third, large operator graphs mandate complex pipeline parallel distributed training, which tends to require a balanced pipeline to run efficiently. This results in a circular dependency between determining what ought to run in each stage of the pipeline and determining an appropriate architecture for each stage. One approach to resolve this is to search through the space of accelerator architectures, and for each candidate architecture determine the model splits and evaluate the corresponding end-to-end runtime. Given that the search space for candidate architectures is large, the present concepts offer an alternate technical solution. WHAM first splits the model based on accelerator HBM capacity and tunes each stage independently based on the computation graph it hosts—thereby supporting heterogeneity of designs.

In a pipeline, however, the bottleneck stage determines the throughput of the system. Thus, to optimize for end-to-end metrics such as Perf/TDP, instead of selecting the best accelerator for each split, WHAM uses the top k designs for each stage to perform a global optimization. These aspects are described in more detail relative to FIG. 2.

FIG. 2 shows another example WHAM system 100B that is similar to WHAM system 100A introduced above. The system 100B includes workload information 102, hardware information 104, graph generator module 106, local architecture search module 108, and global architecture search module 110.

In this example, user inputs 102 include a deep learning workload 114 (e.g., training script), desired number of accelerators and pipelining strategy 202, optimization metric 116, and constraints 118, such as area and power constraints. For example, users can either specify throughput or efficiency as the optimization metric.

The user inputs 102 are supplied to the graph generator module 106 and the local architecture search module 108. Hardware information 104, such as the architectural template 126 is also supplied to the local architecture search module 108.

The architectural template 126 defines the scope of an accelerator design (e.g., all of the available component options, such as type of cores 203 and number of cores). The architectural template 126 can be updated as new core types are developed. An example architectural template with multiple cores 203 is shown and discussed relative to FIG. 3. Briefly, tensor cores and vector cores are two commonly employed core types for executing deep learning models. For instance, tensor cores execute deep learning operators for matrix operations and vector cores execute activation and dot-product type operations. Each core consists of processing engines (PEs) that perform scalar operations. WHAM system 100B optimizes each core (number of PEs and core-dimensions), number of cores, and on-chip memory. As mentioned above, this architectural template 126 is supplied to the local architecture search module 108. This aspect will be discussed in more detail below.

The graph generator module 106 functions to identify operators in the workload and the relationships between the operators. Toward this end, the graph generator module 106 generates a directed acyclic graph, splits the graph across accelerators, and performs graph optimizations. The graph generator module 106 also performs static compiler optimizations to maximize on-chip buffer use.

The graph generator module 106 includes an operator graph generator sub-module 204, a model splitter sub-module 206, and an operator fusion sub-module 208. The operator graph generator sub module 204 generates input for the local and global architecture search problem. Briefly, the operator graph generator sub-module 204 extracts operators from the training script (e.g., the DL workload 114). The operator graph is at the operator granularity with nodes representing matrix operations (convolutions and matrix multiplication), vector operations (relu, softmax, batchnorm), their corresponding gradient operators during the backward pass, and data dependencies between them. Individual operators are not split across cores and execute on a single core (such as tensor or vector). This level of operator granularity offers enough inter-operator parallelism for the cores to exploit.

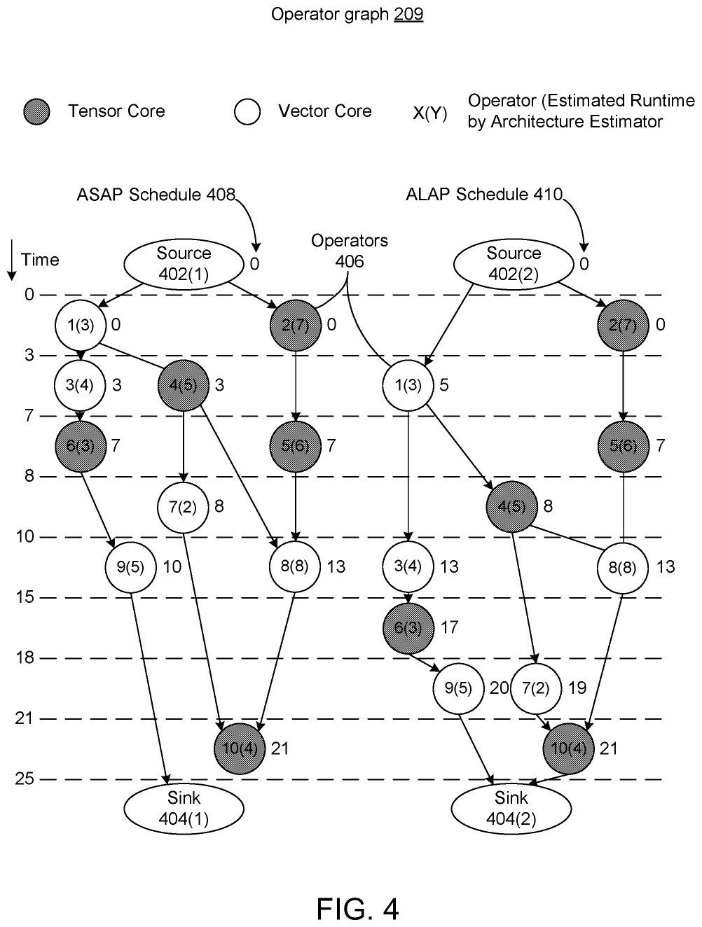

The operator graph generator sub-module 204 extracts a fine-grained operator level graph 209 (forward and backward pass) from standard PyTorch training script (e.g., from the DL workload 114). An example operator graph 209 is shown and described relative to FIG. 4. The operator graph generator sub-module 204 breaks down the high-level layers (Transformer encoder, LSTM, etc.) into fine grained operations (GEMM, Softmax, Layernorm etc.) that maps to cores, such as tensor and vector cores. This operator graph 209 enables detailed architectural estimation along with end-to-end workload latency for training. The operator graph generator sub-module 204 can obtain the operator graph by attaching forward and backward hooks to extract the tensor details relating to performance estimation. This extraction can be achieved with one training iteration execution to gather all the forward and backward operators and their dependencies.

The model splitter sub-module 206 enables distributed training. The model splitter sub-module 206 partitions the operator graph across as many accelerators as provided by the user or the minimum number of accelerators required/recommended to fit a DL model (e.g., the DL workload 114). This is based on the user provided pipeline strategy, training mode, and the capacity of the accelerator's HBM. This model splitter sub-module 206 ensures a memory balanced pipeline, where each split of the operator graph is explored for architecture and schedule.

The model splitter sub-module 206 partitions the DL model from the DL workload based on the HBM capacity and the memory footprint of training. WHAM supports multiple pipeline strategies, such as GPipe and PipeDream-Flush, with and without re-computation. GPipe requires activation stashing for the whole mini-batch while PipeDream-Flush stashes only for in-flight micro batches equivalent to pipeline depth. With re-computation, input activations for each stage are stashed, and intermediate activations are recomputed during backward pass. Based on the pipelining strategy and training mode, the DL model is evenly divided across accelerators. The number of accelerators is either fed as a user input or determined automatically. For the latter, a minimum number of accelerators are used that can fit the model's parameters, activations, and gradients.

The operator-fusion sub-module 208 performs operator-graph optimizations considering the memory hierarchy of the accelerator. In DNNs, a convolution or GEMM operator is often followed by an activation function. Convolution and GEMM operators use tensor cores, while activation functions use vector cores. These operators are fused to reduce data movement across HBM and on-chip SRAM into a single operation and schedule the operation on the computational units that have both a tensor and a vector core.

However, unlike inference, for training with activation stashing, intermediate activations of fused operators are not simply forwarded and discarded post use. These intermediate activations are utilized during the backward pass. Hence, even after fusion, information about the intermediate stashing is preserved in the graph. The operator fusion module 208 takes, as input, the entire DNN graph in case of single accelerator or subgraph of each pipeline stage for distributed training. Performing op-fusion provides on average 15% higher throughput across workloads when training on a TPUv2-like architecture.

The local architecture search module 108 performs architecture and scheduling search for each split of the model. Local architecture search module 108 includes an architecture estimator sub-module 210, critical path analyzer sub-module 212, architecture search sub-module 214, convergence checker sub-module 216, and architecture configuration generator sub-module 218. Note that the local architecture search module 108 tends to operate in an iterative manner so the order that its components are now described is somewhat arbitrary and initially may reference elements that have not yet been fully explained.

The architecture estimator sub-module 210 performs two tasks. First, as indicated at 220, the architecture estimator sub-module 210 annotates the operator graph 209 (e.g., workload operations 124 of FIG. 1) with information used by the critical path analyzer sub-module 212. The architecture estimator sub-module 210 also determines the power and area of the architecture as indicated at 222.

The present WHAM concepts support both stashing and re-computation for pipeline parallel distributed training. Toward this end, the architecture estimator sub-module 210 annotates the latencies for both the modes. In the case of stashing, the forward pass operator latency estimation includes both operator execution time and writing the results back to HBM, whereas backward pass incorporates reading activations from HBM and operator execution. In the case of re-computation, forward pass estimation only stores operator execution time, whereas backward pass estimation additionally includes the time for forward re-execution. These modes allow the user to explore architectural trade-offs between operator compute time, HBM read/write latency, and activation memory requirement. As indicated at 226, tools such as Accelergy can be used for energy estimation of each operation.

In some implementations, architecture estimator sub-module 210 determines the power and area of the architecture assuming a single computational unit. For this, the architecture estimator sub-module 210 determines the on-chip storage per core based on the <TC-Dim,VC-Width> and data tile size defined by dataflow. <TC_{L2-SRAM)}, TC_{L1-REG}> are determined based on TC-Dim and dataflow employed by Timeloop/MAESTRO mapping indicated at 228. Similarly, <TC_{L2-SRAM}> is determined based on the VC-Width to ensure that the vector core is fully utilized. As mentioned above, Accelergy can be used for area estimation of on-chip memory in the architecture as indicated at 226. An analytical model is used to estimate the power consumption of the accelerator on an industry 45-nm standard manufacturing process. This process is readily adaptable to advances in chip technology that produce smaller chips. Power is estimated assuming 100% utilization of each component of the accelerator.

The architecture estimator sub-module 210 provides operator-level information such as which core executes the operator along with its latency and energy consumption to execute the operator. Based on this information and the dataflow of the operators, the critical path analyzer sub-module 212 determines the best possible latency that can be achieved assuming infinite resources, i.e., no area/power constraints as indicated at 230.

WHAM does not search exhaustively through a large design space of architectures and rely on black-box optimizers. Instead, it takes an algorithmic approach towards the architectural search problem. In regard to theoretical best latency, for every, <TC-Dim,VC-Width> the critical path analyzer sub-module 212 determines the theoretical best possible latency an individual operator graph can achieve and uses it as roofline. The critical path analyzer sub-module 212 uses ‘as soon as possible’ (ASAP) scheduling to obtain the best possible latency for both the forward and the backward pass of the operator graph. The ASAP scheduling assumes an infinite number of cores of each type in the architecture. Thus, the parallelization of concurrent operators within the operator graph is fully exploited and each operator is scheduled as soon as the operator's predecessors are complete. This aspect is described in additional detail below relative to FIG. 4.

The critical path analyzer sub-module 212 also determines the latency critical operators. The critical path analyzer sub-module 212 employs ‘as late as possible’ (ALAP) schedule. The ALAP schedule assumes infinite computation cores, where each operator is scheduled as late as possible without having any impact on the overall theoretical best latency by ASAP. Operators with same ASAP and ALAP time are the critical operators. These operators cannot have any slack in their scheduling window. This aspect is described in additional detail below relative to FIG. 4.

As indicated at 230, the critical path analyzer sub-module 212 forwards the ASAP and ALAP schedule for each forward and backwards operator and the best possible latency to the architecture search sub-module 214. The architecture search sub-module 214 uses novel heuristic-based and ILP algorithms to strategically determine the best possible dimensions and core count as per the needs of the workload—while being within area and power constraints.

The architecture search sub-module 214 performs a local search that determines the design of a single accelerator <#TC, TC-Dim, #VC, VC-Width>, on-chip memory, configuration of the computational units, and the schedule of operators as indicated at 232. The TC-Dim, VC-Width, and on-chip memory are provided by the architecture configuration generator sub-module 218, whereas the rest is determined by critical path analyzer sub-module 212 and the architecture search sub-module 214.

Architecture search sub-module 214 tunes the number of each accelerator core type, such as tensor cores and vector cores, and computational units. The Architecture search sub-module 214 can also provide the schedule of operators used by the architecture configuration generator sub-module 218, by architecture estimator sub-module 210, and roofline analysis performed by critical path analyzer sub-module 212. This search is performed by WHAM heuristics or ILP.

WHAM offers a technical solution relating to critical path guided heuristics. WHAM offers two novel heuristic-based searches for tuning the number of cores for every architecture configuration. This technical solution offers a critical path-based approach towards deep learning architecture search. Both the heuristics begin with a single core of <TC-Dim,VC-Width>. The heuristics iteratively determine which core needs to be added. Every iteration adds one core type, such as one tensor core, vector core, or other core, or an entirely new computational unit with two cores, such as a vector core and a tensor core.

First Conflict First (FCF) is shown in Algorithm 1. The criterion to add a core is as follows: operators are scheduled on the current number of TCs and VCs, and if a resource conflict causes a delay for an operator beyond its slack in ALAP schedule, the core that executes the operator is added. Fused operator is executed on a computational unit with both tensor cores and vector cores. The novel aspect for FCF is that, if an operator's start time is beyond its ALAP schedule time, it would increase the overall latency of the graph execution. If adding the core/unit to the first conflict does not violate the area and power constraints, the change is final. The iterative process of FCF builds on this change until an addition is invalidated due to area and power constraints, the architecture converges to theoretical best possible latency, or there is no operator left with a conflict that causes the time to cross ALAP start time.

Algorithm 1: First Conflict First

```
Input: G(V, E), M(V) Cores
Result: Core_{conflict}
nodes ← G(V, E);
RC ← Resource Conflict;
delay_{critical} ← scheduleₜᵢₘₑ − ALAPₜᵢₘₑ;
Core_{conflict} ← None;
foreach no de ∈ nodes do
  if RC &delay_{critical} ≥ 0 then
    break
Core_{conflict} ← M(node);
```

Worst Conflict First (WCF) is an iterative process, where a core/unit is added for an operator that observes the worst ALAP delay. The novel aspect is that this delay would increase the end-to-end latency by worst latency. Unlike FCF that mitigates first conflict to potentially resolve subsequent conflicts as well, with WCF, this technique tackles the worst delay head on. However, worst delays can occur later in the execution and might not have an impact on earlier less-bad conflicts. The WCF heuristics are shown in Algorithm 2. WCF convergence depends on whether the user constraint compliance is achieved or if the best possible runtime is achieved.

Algorithm 2: First Conflict First

```
Input: G(V, E), M(V) Cores
Result: Core_{conflict}
nodes ← G(V, E);
RC ← Resource Conflict;
delay_{ALAP} ← scheduleₜᵢₘₑ − ALAPₜᵢₘₑ;
delay_{ready} ← scheduleₜᵢₘₑ − readyₜᵢₘₑ;
Core_{conflict} ← None;
foreach node ∈ nodes do
  delayₘᵢₙ ← min (delay_{ALAP}, delay_{ready});
  if RC &delayₘᵢₙ ≥ 0 & delayₘᵢₙ ≥ delayₘₐₓ then
    v ← node;
    delayₘₐₓ ← delayₘᵢₙ
Core_{conflict} ← M(v);
```

Critical path analyzer sub-module 212 also generates the schedule of operators for each iteration of the architecture search, based on the tuned number of cores. Operators are scheduled in a greedy manner. The operator is scheduled to a core if all its predecessors are completed and the required core is free to use. A fused operator is scheduled for a computational unit with both of the core types. In case two operators are ready to be scheduled but not enough cores are available, the order is determined based on the operator criticality. The combination of ASAP/ALAP schedule defines the slack for the start time of each operator. The operators with zero slack tend to be the most critical. For the remainder of operators, higher the slack, lower priority, and vice-versa. To reduce the idle time, a low priority operator can be added prior to a critical operator when doing so does not impact the start time of critical operator.

Architecture search sub-module 214 traverses the graph in a breadth first manner. The order of operators within a core/unit adheres to the dependencies in the graph. All the operators within a single computational unit only need to be executed in order. Across units the dependencies are maintained using a semaphore block.

The architecture search sub-module's novel heuristics and operator schedule take a deliberate critical path-based approach towards architecture and scheduling search. Unlike traditional configurations, WHAM does not have to search through a large space of architectures and select the best design, instead WHAM creates a targeted and deliberated architecture for the training task in a piece-wise manner.

As an alternative to heuristics, architecture search sub-module 214 offers a specific integer linear program formulation for this optimization problem. The solution will offer formal guarantees of being optimal.

One goal of ILP is to minimize the training time with area and power constraints while co-optimizing the number of cores needed for a DNN training workload and the schedule for the operator graph for an algorithmically optimized solution. The ILP for the problem is described directly below.

Let G(V, E) denote the operator graph with vertex set V and edge set E. Use v to denote a single vertex in V and E for a single directed edge in E. Let ΔV denote the estimated latency (execution time) of each operator V. Possible types of cores are denoted by C. In this implementation assume C=[TensorCore,VectorCore]. However, this ILP formulation works for any set C. For a core c∈C, the variable x(c) denotes the number of cores of type c the solution uses. This technique operates on the assumption that x(c)≥1 by preprocessing the input. The function M:V→C gives a mapping of operators V to computational core C; an operator v∈V needs to be processed on the core M(v). Let A(c), P(c) denote the area utilization and power consumption of each unit of core c, and let A, P denote the total area and power constraints. This technique can require that the total area and power used by all computational cores is at most A,P. This implementation appends a (dummy) sink node v* to the end of DAG and creates directed edges from all other operators to v*. This technique operates on the assumption that execution time of v* is 0 and chose M(v*) arbitrarily.

The main decision variables of this ILP are y(v,t), that indicate when the operator v is scheduled. This technique assumes that time is slotted and entire operator DAG can be feasibly scheduled in T time slots. The process generates an estimate of T by doing a binary search. For an operator v,y(v,t)=1 only if v starts its execution at time slot t. If y(v, t)=1, then it means that operator v is scheduled on core M(v) in the contiguous set of time slots between [t, t+Δv−1].

ILP Objectives: This technique aims to minimize the training time, area, and power, and formulates a multiple objective ILP.

The first objective minimizes the training iteration time by tuning the number of cores. The formula it as follows:

$${\sum }_{c ∈ T} t \cdot {y}_{( {v}^{*} , t )}$$

The second objective minimizes the area and power consumption while keeping it within the constraints.

$$f ( z ) = {\sum }_{c} x ( c ) \cdot A ( c ) , f ( p ) = {\sum }_{c} x ( c ) \cdot P ( c )$$

$$f ( z ) \leq A , f ( p ) \leq P$$

ILP Constraints: The constraints ensure a valid schedule of operators is obtained that respects the graph dependencies.

The first set of constraints enforce that each operator gets scheduled only once and is executed non-preemptively.

$${\sum }_{c ∈ T} {y}_{( v , t )} = 1 ∀ v ∈ V$$

Next the technique enforces capacity constraints. This technique ensures that the total number of operators that require computational core c at any time t is the tuned number of computational cores.

$${\sum }_{v ∈ V , M ( v ) = c} {\sum }_{{t}^{′} = t - ( Δ v - 1 )}^{t} y ( v , {t}^{′} ) \leq x ( c ) ∀ t ∈ T , c ∈ C$$

The above constraint implies that if an operator v has a start time t′ (that is, y(v, t′)=1) then it would require core M(v) for the entire duration of [t′, t′+Δv−1].

Finally, the technique can cause the operators to be scheduled in order of their precedence within the operator graph.

$${\sum }_{t ∈ T} t \cdot {y}_{( {v}^{′} , t )} - {\sum }_{t ∈ T} t \cdot {y}_{( v , t )} \geq {Δ}_{v} ∀ e : ( v , {v}^{′} ) ∈ E , v \to {v}^{′}$$

ILP Outputs: As output, ILP provides the optimal number of cores (variable x(c)), required for the workload within the area and power constraints. It also provides the optimal schedule of operators to get the best possible latency. These techniques obtain the optimal schedule from variable y(v, t) of each operator v.

The convergence checker sub-module 216 determines when the <TC-Dim,VC-Wdith> architecture configuration generator sub-module 218, critical path analyzer sub-module 212, and architecture search (Heuristics/ILP) sub-module 214 converge to terminate the local architecture search. Each iteration explores a single architecture configuration and provides the respective normalized metrics (throughput and Perf/TDP). The convergence checker sub-module 216 tracks Top-k performing architectures utilized by the global architecture search module 110. Instead of defining a fixed number of iterations as done by traditional processes, convergence checker sub-module 216 adapts the number of iterations for each DL workload and can terminate early if an architecture configuration with best possible latency of ASAP is found. For general termination, convergence checker sub-module 216 tracks the optimization metric of last x iterations. x is a hyper-parameter for the search block. If for last x number of iterations, the normalized metric does not improve or performs worse than the best-known top-k architecture configurations, the convergence checker sub-module 216 terminates the search. For instance, an x of 100 can find a Pareto frontier across end-to-end training metrics of throughput and Perf/TDP. As used here, Pareto frontier is the set of all Pareto efficient solutions (e.g., the convergence can ‘focus’ or ‘weight’ a set of solutions rather than fully considering every parameter fully and equally).

From one perspective, when optimizing for a set of workloads, convergence checker sub-module 216 tracks a weighted average of the metric of interest. Weighted average is used in case the user wants a biased architecture towards certain workloads in a set. This aspect can be deployed with platforms such as ASICs that are better suited for homogeneity, based on the workloads' common compute, data flow, and memory requirements. For this evaluation, where the set includes multiple workloads, the same weight is given to each workload in this implementation. Other configurations could weight workloads differently.

The architecture configuration generator sub-module 218 annotates each operator in the graph with the following—the type of core it is executed on, latency to execute on this core, and energy expended during the operation as indicated at 234. As each operator executes on a single core, architecture configuration generator sub-module 218 utilizes the tensor core-dimensions (TC-Dim) and vector core width (VC Width) to determine the aforementioned information. (These dimensions are shown in FIG. 3). This can be established utilizing open-source tools like Timeloop and MAESTRO as indicated at 228 to determine the performance of Conv2D, DepthwiseConv2D, grouped convolution, and MatMul operators. For all the other operators, such as vector and point-wise operations, performance is modeled using novel custom models.

The architecture configuration generator sub-module 218 iteratively generates the <TC-Dim,VC-Wdith> of the design. The architecture configuration generator sub-module 218 starts with the largest architecture for TC-Dim and VC-Width, respectively. The entire local architecture search is an iterative process, where the configuration generated by this sub-module remains constant per iteration and is consumed by the other sub-modules. The architecture configuration generator sub-module 218 generates a new configuration for the next iteration by reducing the tensor and vector core dimensions. The dimensions are reduced in the step size of 2, 4, 6 . . . up to 64; even non-power of 2s are allowed to enable a larger design space exploration. This explanation utilizes a step size of 2 for both tensor core and vector core dimensions.

The architecture configuration generator sub-module 218 is operating cooperatively with the convergence checker sub-module 216, which is introduced above, and which is reviewed here. The convergence checker sub-module 216 determines when the architecture configuration generator sub-module 218, critical path analyzer sub-module 212, and architecture search sub-module (Heuristics/ILP) 214 converge to terminate the local architecture search. Each iteration explores a single architecture configuration and provides the respective normalized metrics (throughput and Perf/TDP). Convergence checker sub-module 216 tracks Top-k performing architectures required by the global architecture search module 110. Instead of defining a fixed number of iterations as prior work, WHAM adapts the number of iterations for each workload and can terminate early if architecture configuration with best possible latency of ASAP is found. For general termination, convergence checker sub-module 216 tracks the optimization metric of last x iterations. x is a hyper-parameter for the search block. If for last x number of iterations, the normalized metric does not improve or performs worse than the best-known top-k architecture configurations, convergence checker sub-module 216 terminates the search.

When optimizing for a set of workloads, convergence checker sub-module 216 tracks a weighted average of the metric of interest. Weighted average is used in case the user wants a biased architecture towards certain workloads in a set. WHAM can be deployed with platforms such as ASICs that are better suitable for homogeneity, based on the workloads' common compute, data flow, and memory requirements.

One goal of the above-described local architecture search module 108 is to provide an architecture and a static schedule of operators that exploit the parallelism in the DL graph, prioritize resources for critical operators, and leverage data reuse within a computational unit via op-fusion. Another opportunity for WHAM is to exploit runtime data re-use. A runtime scheduler (not specifically shown) does so when an in-flight operator and an operator ready to be scheduled share intermediate results. This reduces the costly round trip to HBM as data is directly consumed on the chip. If both the operators are on the same computational unit (but not fused), intermediate activations stay within the unit's buffer and are fetched for next operator. Data sharing across computation units data uses the NOC. The activations, in the stashing mode, are stored in HBM for the backward pass.

The global architecture search module 110 includes a global architecture optimizer sub-module 236 and a bottleneck pipeline identifier sub-module 238. The global architecture search module 110 takes a set of designs (e.g., top-k) from the local architecture search module 108 as indicated at 240. The global architecture optimizer sub-module 236 searches for every split in these top-k designs. The bottleneck pipeline identifier sub-module 238 then identifies the bottleneck stage and selects the best accelerator from the top-k options for other stages to reduce the collective area across designs. This does not have any impact on the throughput of the pipeline and improves the Perf/TDP. This enables heterogeneous architectures for pipeline parallel training, which is a unique dimension of the WHAM concepts, and can be deployed in clouds with reconfigurable fabrics such as FPGAs.

As mentioned above, larger DL models mandate pipeline parallel training, as their memory footprint tends to exceed the memory capacity of a single accelerator. Having a balanced pipeline can be crucial to achieving high throughput and utilization. Existing techniques balance the workload across the pipeline by assuming predefined homogeneous architectures. However, in the present implementations the architecture and its corresponding runtime execution is tunable. As such, the balanced pipeline problem is split into two parts. First, the model splitter sub-module 206 partitions the operator graph based on HBM capacity and memory requirements of training a workload to achieve a memory balanced pipeline. This aspect is described above. Next, the global architecture search module 110 enables heterogeneous designs in the pipeline to balance the runtime of each accelerator.

Architecture search sub-module 214 independently performs local hardware search either through ILP or the heuristics for each accelerator based on its partitioned operator graph. Local architecture search tracks top-k architectures for each accelerator. Using this information, global architecture search module 110 collectively reduces the area of all the accelerators to obtain the same throughput as compared to the case where each architecture was the best individual design. To globally optimize the pipeline, global architecture optimizer sub-module 236 search leverages the fact that in a pipeline, the system throughput is determined by the slowest accelerator. Based on the bottleneck accelerator, the bottleneck pipeline identifier sub-module 238 search tries to find the best combination of all the accelerators in the pipeline out of the top-k tuned accelerators with the condition that the latency of each is always to the bottlenecked accelerator.

This combination is output as the recommended hardware architecture 128 and schedule recommendations 130. The recommended hardware architecture 128 includes the best performing combinations of components, including accelerator types, numbers of each accelerator type, memory, etc. for accomplishing the set of one or more DL workloads 114 on the recommended hardware architecture 128. Thus, the novel output of the WHAM system 100B is recommended hardware architecture 128 that is customized to the user's DL workload 114. This recommended hardware architecture provides a technical solution that defines what types of accelerators to employ, and in what ratios, to efficiently/optimally perform the user's DL workload whether the DL workload is a single workload or multiple DL workloads.

Many modules and sub-modules of WHAM system 1008 are introduced and explained above in relation to WHAM concepts. For purposes of review and further explanation WHAM system 100B is now discussed from a functional standpoint. As explained above, WHAM can examiner one or more accelerators as defined by the user. In the case of a single accelerator, with throughput as the user defined optimization metric 116, WHAM system 100B converges on a design (e.g., recommended hardware architecture 128) that maximizes end-to-end training throughput while being within the area and power constraints. With Perf/TDP as the user defined optimization metric 116, WHAM system 100B converges on a design (e.g., recommended hardware architecture 128) that maximizes Perf/TDP while maintaining a user specified minimum end-to-end training throughput.

The WHAM system 100B tunes the architectural template that entails established compute cores that execute deep learning operations. The system determines the schedule of operators onto the accelerator, and effectively utilizes the memory subsystem, limited on-chip memory (few hundred KBs) and a tightly coupled high-bandwidth memory (HBM), to optimize end-to-end training metrics.

First, WHAM system 100B incorporates architectural template 126, which defines the scope of a single accelerator design. WHAM system 100B can tune this architecture on a per-workload basis or find a design for a set of workloads. This architectural template contains well-established cores that execute deep learning operators such as tensor cores for matrix operations and vector cores for activation and dot-product type operations. Each core consists of processing engines (PEs) that perform scalar operations. WHAM system 100B optimizes each core (number of PEs and core-dimensions), number of cores, and the on-chip memory.

WHAM system 100B also co-optimizes the schedule of operators. These operators are extracted from the training script by the graph generator module 106. The graph is at the operator granularity with nodes representing matrix operations (convolutions and matrix multiplication), vector operations (relu, softmax, batchnorm), their corresponding gradient operators during the backward pass, and data dependencies between them. Individual operators are not split across cores and execute on a single core (e.g., tensor or vector). This operator granularity offers enough inter-operator parallelism for the cores to exploit. The graph generator module also performs static compiler optimizations to maximize on-chip buffer use.

The local architecture search module 108 performs the architectural and scheduling search on a single accelerator. First the architecture estimator sub-module 210 provides operator-level information such as which core executes the operator along with its latency and energy consumption to execute the operator. The critical path analyzer sub-module 212 utilizes this information and the dataflow of the operators to determine the best possible latency that can be achieved assuming infinite resources, i.e., no area/power constraints. This critical path information is fed into the architecture search sub-module 214. This architecture search sub-module 214 uses novel heuristic based and ILP algorithms to strategically determine the best possible dimensions and core count as per the needs of the workload while being within area and power constraints.

Large DL models mandate pipeline parallel training that splits the model across multiple accelerators. To further alleviate memory overheads, intermediate activations that normally need to be stashed after forward pass, can instead be discarded and recomputed during backward pass. WHAM system 100B is the first system to support architectural exploration for pipeline parallel training with both activation stashing and re-computation.

WHAM employs model splitter sub-module 206 to enable distributed training. The model splitter sub-module 206 partitions the operator graph across as many accelerators as provided by the user or the minimum number of accelerators required to fit a model. This is based on the user provided pipeline strategy, training mode, and the capacity of the accelerator's HBM. This model splitter sub-module 206 ensures a memory balanced pipeline, where each split of the operator graph is explored for architecture and schedule.

Next, to balance work across the architectures, WHAM system 100B employs global architecture search module 110. The global architecture search module 110 takes top-k designs from the local architecture search module 108 for every split. The global architecture search module 110 then identifies the bottleneck stage, and selects the best accelerator from the top-k options for other stages to reduce the collective area across designs. This does not have any impact on the throughput of the pipeline and improves the Perf/TDP. This enables heterogeneous architectures for pipeline parallel training, which is a novel feature that can be deployed in clouds with reconfigurable fabrics such as FPGAs.

FIG. 3 shows micro-architectural details of an example architectural template 126. WHAM explores core types 203 and core dimensions. In the illustrated configuration, the core types are vector cores and tensor cores. The explored aspects are TC dimensions, VC dimensions, a number of TC and VCs, and on-chip memory size.

The architectural template 126 consists of computational units 302, where each computational unit (CU) 302 is composed of at most one Tensor Core 304, one Vector Core 306, or both. Tensor cores 304 are a 2-D array of Processing Engines (PEs) 308 as labelled in two directions ‘TX_x’ and ‘TC_y.’ Vector cores are 1-D arrays of processing engines 308 as labelled ‘VC_w.’ (Only representative processing engines 308 are labelled on the drawing page to reduce clutter). Each processing engine 308 performs a scalar operation, and together as a core they can perform larger operations such as convolutions. Each core in the computational unit 302 also has dedicated on-chip storage 310. On tensor cores 304, the storage 310 is manifest as shared level two (L2) SRAM 312 and private level one (L1) 314 register of each PE 308. On vector cores 306, the storage 310 is manifest as shared L2 SRAM 316. (Only representative storage instances 314 and 316 are labelled on the drawing page to reduce clutter). This is common across deep learning architectures as parameters and intermediate activations are often shared across operators.

The inputs and outputs to each core 304 or 306 are fed by and stored into the corresponding L2 SRAM 312. To support training, intermediate activations are stashed for backward pass, in HBM 318 via L2 SRAM. Scheduler 320 operates cooperatively with cross-CU controller 321 across the cores 304 and 306 to generate control signals to execute each operator via instruction dispatcher 322 and a set of controllable FIFOs. Data transfer between cores is handled by a dedicated network-on-chip.

TABLE 1

| Parameter Description | Notation | Range of Values |
|---|---|---|
| No. of Tensor Cores | #TC | 1 to 256 |
| Tensor Core x dim | TC_x | 4 to 256 |
| Tensor Core y dim | TC_y | 4 to 256 |
| No. of Vector Cores | #VC | 1 to 256 |
| Vector Core width | VC_w | 4 to 256 |
| Tensor Core PE L1 Reg | TC_L1_reg | 100 Bytes to 1 MB |
| Tensor Core L2 SRAM | TC_L2_sram | 1 KB to 128 MB |
| Tensor Core L2 SCRAM | VC_L2_sram | 1 KB to 64 MB |

Table 1 shows example tunable parameters of this architectural template 126 to cover a wide range of architectures. (Note that other components having other parameters can alternatively or additionally be employed.) Henceforth, every architecture design point is represented as follows: <#TC,TCDim,#VC,VC-Width>, that is, number of TCs, 2-dimensions of the TC, number of VCs, and 1-dimension of the VC, respectively. The dimensionality for each core type is the same for a given configuration. On-chip storage is represented as <T CL2-SRAM,T CL1-REG,V CL2-SRAM>. This tunability enables WHAM to not be specific to a particular family of accelerators and to instead explore designs based on the compute, memory, and dataflow requirements of the model. Based upon this tunability, the architectural template can be viewed as a ‘tunable architectural template’ 126. The tunable architectural template 126 can include multiple possible hardware component options for accelerator hardware configurations. WHAM can ‘build’ accelerators from selected specific component combinations to achieve the DL workload. One or more of these accelerator configurations can be presented as the hardware architecture 128 for accomplishing the DL workload. In some cases, more than one hardware architecture 128 can be presented. For instance, a set of high-ranking hardware architectures can be presented so that the user can compare them and decide which to select based upon their relative attributes.

FIG. 4 shows an example operator (level) graph 209 that starts at a source 402 and ends at a sink 404 after a duration of time represented on the vertical axis. Operators 406 (only some of which are labelled) are represented as spheres. Relative execution times are shown next to each operator. The operators are color coded to indicate upon which core type they are executed. This operator graph 209 enables detailed architectural estimation along with end-to-end workload latency for training. In this case, the operator graph is illustrated with ASAP scheduling 408 to obtain the best possible latency for both the forward and the backward pass of the operator graph. The ASAP scheduling assumes an infinite number of cores of each type in the architecture. The operator graph 209 is also shown relative to ‘as late as possible’ (ALAP) scheduling 410. The ALAP schedule assumes infinite computation cores, where each operator is scheduled as late as possible without having any impact on the overall theoretical best latency by ASAP.

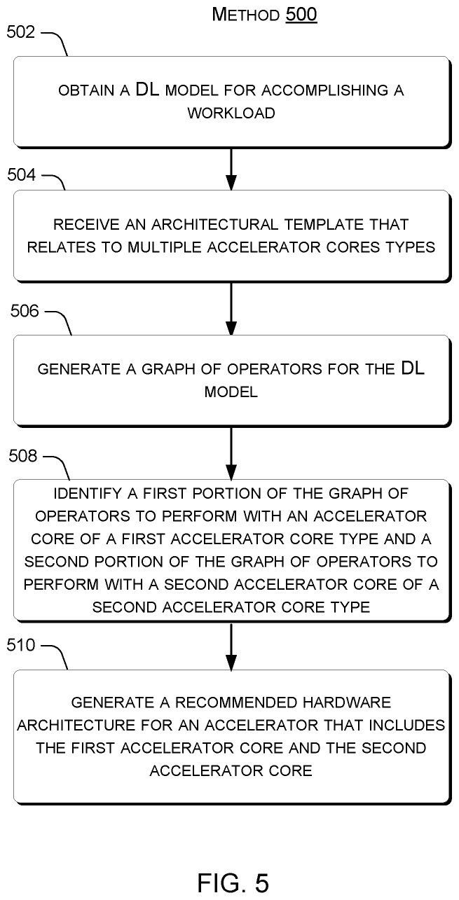

Several implementations are described in detail above. FIG. 5 shows an example workload-aware hardware architecture recommendation method or technique 500.

Block 502 can obtain a DL model for accomplishing a workload.

Block 504 can receive an architectural template that relates to multiple accelerator core types.

Block 506 can generate a graph of operators for the DL model.

Block 508 can identify a first portion of the graph of operators to perform with an accelerator core of a first accelerator core type and a second portion of the graph of operators to perform with a second accelerator core of a second accelerator core type.

Block 510 can generate a recommended hardware architecture for an accelerator that includes the first accelerator core and the second accelerator core. In one example, the generating can entail generating a graphical user interface (GUI) that defines or otherwise shows the recommended hardware architecture. The GUI can be presented on a user device, which may or may not be the same device that generated the GUI.

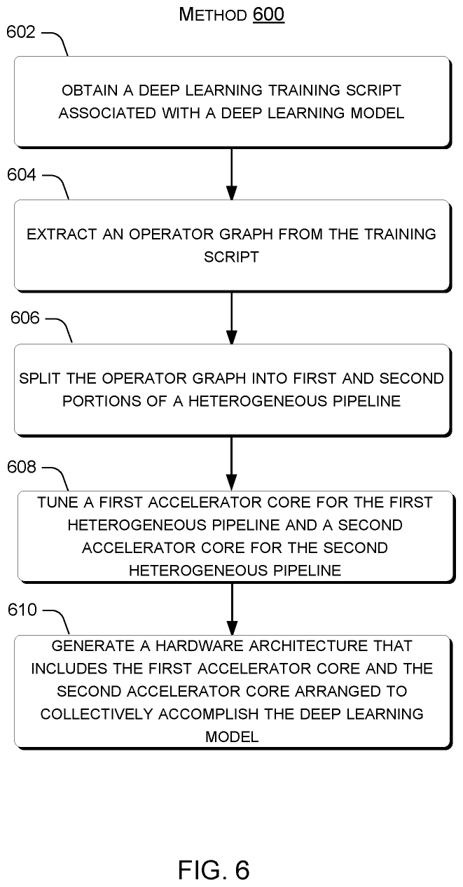

FIG. 6 shows an example method or technique 600.

Block 602 can obtain a deep learning training script associated with a deep learning model.

Block 604 can extract an operator graph from the training script.

Block 606 can split the operator graph into first and second heterogeneous pipelines.

Block 608 can tune a first accelerator core for the first heterogeneous pipeline and a second accelerator core for the second heterogeneous pipeline.

Block 610 can generate a hardware architecture that includes the first accelerator core and the second accelerator core arranged to collectively accomplish the deep learning model.

The order in which the disclosed methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage media as a set of instructions such that execution by a processor of a computing device causes the computing device to perform the method.

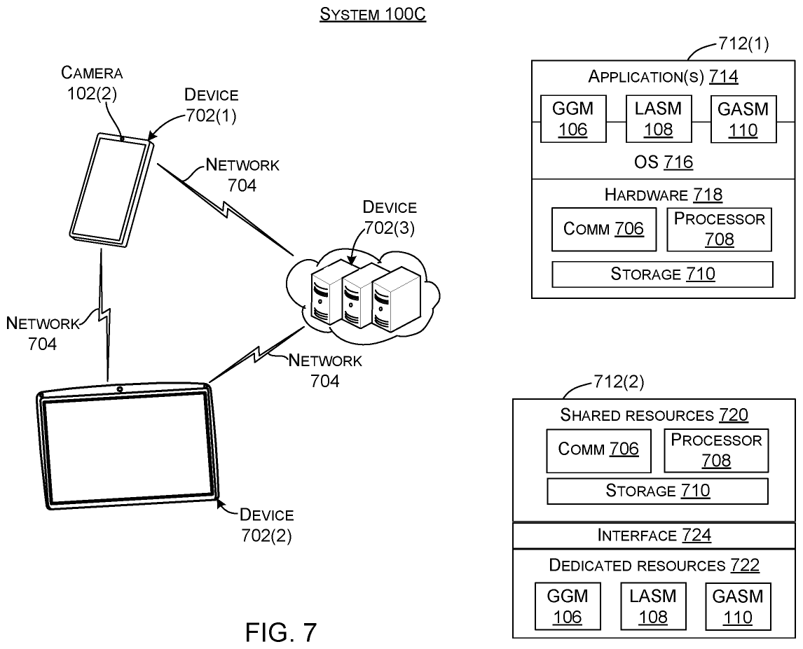

FIG. 7 shows an example system 100C. System 100C can include computing devices 702. In the illustrated configuration, computing device 702(1) is manifest as a smartphone, computing device 702(2) is manifest as a tablet type device, and computing device 702(3) is manifest as a server type computing device, such as may be found in a datacenter. Computing devices 702 can be coupled via one or more networks 704 that are represented by lightning bolts.

Computing devices 702 can include a communication component 706, a processor 708, storage 710, graph generator module (GGM) 106, local architecture search module (LASM) 108, and/or global architecture search module (GASM) 110.

FIG. 7 shows two device configurations 712 that can be employed by computing devices 702. Individual devices 702 can employ either of configurations 712(1) or 712(2), or an alternate configuration. (Due to space constraints on the drawing page, one instance of each configuration is illustrated). Briefly, device configuration 712(1) represents an operating system (OS) centric configuration. Device configuration 712(2) represents a system on a chip (SOC) configuration. Device configuration 712(1) is organized into one or more applications 714, operating system 716, and hardware 718. Device configuration 712(2) is organized into shared resources 720, dedicated resources 722, and an interface 724 therebetween.

In configuration 712(1), the graph generator module 106, local architecture search module 108, and/or global architecture search module 110 can be manifest as part of the processor 708. Alternatively, the graph generator module 106, local architecture search module 108, and/or global architecture search module 110 can be manifest as applications 714 that operates in conjunction with the processor 708. In configuration 712(2), the graph generator module 106, local architecture search module 108, and/or global architecture search module 110 can be manifest as part of the processor 708 or a dedicated resource 722 that operates cooperatively with the processor 708.

In some configurations, each of computing devices 702 can have an instance of the graph generator module 106, local architecture search module 108, and/or global architecture search module 110. However, the functionalities that can be performed by the graph generator module 106, local architecture search module 108, and/or global architecture search module 110 may be the same or they may be different from one another when comparing computing devices. For instance, in some cases, each graph generator module 106, local architecture search module 108, and/or global architecture search module 110 can be robust and provide all of the functionality described above and below (e.g., a device-centric implementation).

In other cases, some devices can employ a less robust instance of the graph generator module 106, local architecture search module 108, and/or global architecture search module 110 that rely on some functionality to be performed by another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 712(2) can be thought of as a system on a chip (SOC) type design. In such a case, functionality provided by the device can be integrated on a single SOC or multiple coupled SOCs. One or more processors 708 can be configured to coordinate with shared resources 720, such as storage 710, etc., and/or one or more dedicated resources 722, such as hardware blocks configured to perform certain specific functionality. Thus, the term “processor” as used relative to FIG. 7 can also refer to central processing units (CPUs), graphical processing units (GPUs), field programmable gate arrays (FPGAs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

### CONCLUSION

The description above relates to hardware architectures. Existing techniques focus on exploration within the realm of specific DNNs and operators popular at the time, such as convolutions and GEMMs in CNNs, and in accelerating them using optimized architectures and dataflows. Unfortunately, they ignore the dependencies across all the operators within a DNN and how these impact the accelerator design. Recent work tackles the problem of looking at the entire computation graph and jointly optimizing compiler decisions and accelerator architecture for Performance/TDP, but is limited to inference on a single accelerator.

Training however exhibits unique challenges. DNN operator graphs for training are much larger than inference, require higher compute intensity during the backward pass, and incur a larger memory footprint. These challenges are further exacerbated as the models become larger and cannot be trained on a single accelerator. Modern DNNs, such as state-of-the art language and image classification models, have grown exponentially in size and mandate distributed execution with complex pipelining strategies. Efficient pipeline-parallel training requires balancing the accelerator load across the stages. This further complicates the hardware architectural search as it requires determining how to partition a model across pipeline stages and estimate the runtime of each partition for specific accelerator architectures while also searching for the ideal architecture for each accelerator.

Overall, as the models, optimizations, architectural complexity, and execution strategies evolve, the search space for the best architecture for a given workload explodes combinatorially. The present concepts break away from an individual operator, single-accelerator, and inference-focused search for an optimized hardware architecture. WHAM implementations are designed with recognition that end-to-end performance (throughput) and efficiency (Perf/TDP) of training a large DL model is influenced by several factors. These factors include hardware configuration, accelerator-specific DNN operator scheduling, and compiler optimizations such as those that minimize data movement. WHAM implementations can provide an end-to-end toolkit for hardware architecture search for distributed DL training workloads.

WHAM performs general and automated multi-dimensional exploration of both the accelerator architecture and its corresponding operator schedule for both a single accelerator execution and multiple accelerators in a distributed pipeline parallel training. WHAM concepts leverage critical path-based heuristics to strategically tune the architecture and operator schedule, optimizing for end-to-end performance (throughput) and efficiency (Perf/TDP), subject to area and power constraints. WHAM concepts also provide a novel ILP formulation for optimization problems to offer guarantees regarding the optimality of the proposed solutions. WHAM's training accelerators provide improvement in training throughput with large Perf/TDP improvements when tuned for individual or a combined set of workloads.

Although techniques, methods, devices, systems, etc., pertaining to WHAM concepts are described in language specific to structural features and/or methodological acts, it is to be understood that the subject matter defined in the appended claims is not necessarily limited to the specific features or acts described. Rather, the specific features and acts are disclosed as example forms of implementing the claimed methods, devices, systems, etc.

Various examples are described above. Additional examples are described below. One example includes a system comprising a graph generator module configured to obtain multiple user DL workloads and graph the DL workloads to operators, a local architecture search module configured to receive an architectural template that relates to accelerator core types and evaluate individual accelerator types at accomplishing sub-sets of the operators, and a global architecture search module configured to evaluate combinations of accelerators of the accelerator types for collectively accomplishing the operators and generate a ranking of accelerator hardware architectures that employs an individual evaluated combination of accelerators for performing the workload.

Another example can include any of the above and/or below examples where the graph generator module comprises an operator graph generator sub-module that is configured to extract the graph from a training script of the DL workload.

Another example can include any of the above and/or below examples where the operator graph generator sub-module is configured to map the operators to accelerator core types.

Another example can include any of the above and/or below examples where the graph generator module comprises a model splitter sub-module that is configured to partition DL models of the DL workload across accelerators.

Another example can include any of the above and/or below examples where the graph generator module comprises a model splitter sub-module that is configured to perform operator graph optimizations that consider a memory hierarchy of the accelerators.

Another example can include any of the above and/or below examples where the local architecture search module comprises an architecture estimator sub-module that is configured to annotate latency estimations associated with execution of individual graph operators and to determine power usage of potential architectures defined by the architectural template.

Another example can include any of the above and/or below examples where the local architecture search module comprises a critical path analyzer sub-module that is configured to identify critical operators and determine latencies of the operators.

Another example can include any of the above and/or below examples where the local architecture search module comprises an architecture search sub-module that is configured to perform a local search to determine a design of a single accelerator.

Another example can include any of the above and/or below examples where the local architecture search module comprises a convergence checker sub-module that is configured to track relative performance of hardware architectures identified by the global architecture search module.

Another example can include any of the above and/or below examples where the local architecture search module comprises an architecture configuration generator sub-module that is configured to annotate each operator in the graph with the type of core the operator executed on, latency to execute on the core, and energy expended during the execution.

Another example can include any of the above and/or below examples where the global architecture search module comprises a global architecture optimizer that is configured to receive a set of architectural designs and identify splits in the designs associated with accelerator latency bottlenecks.

Another example includes a system comprising storage configured to store computer-readable instructions and a processor configured to execute the computer-readable instructions to: obtain a deep learning (DL) model for accomplishing a workload, receive an architectural template that relates to multiple accelerator cores types, generate a graph of operators for the DL model, identify a first portion of the graph of operators to perform with an accelerator core of a first accelerator core type and a second portion of the graph of operators to perform with a second accelerator core of a second accelerator core type, and generate a recommended hardware architecture for an accelerator that includes the first accelerator core and the second accelerator core.

Another example can include any of the above and/or below examples where the workload comprises a training script for the DL model and wherein the architectural template defines areas of each core type and available chip area.

Another example can include any of the above and/or below examples where the identifying comprises performing compiler optimizations on the graph.

Another example can include any of the above and/or below examples where the identifying further comprises generating parallelization schemes for training the DL model.

Another example can include any of the above and/or below examples where the generating recommended accelerator hardware architecture further comprises generating scheduling recommendations for the recommended accelerator hardware architecture.

Another example can include any of the above and/or below examples where the generating recommended accelerator hardware architecture comprises generating recommended hardware architecture and their corresponding schedule accelerator in a pipelined distributed training-based execution.

Another example includes a device-implemented method comprising obtaining a deep learning training script associated with a deep learning model, extracting an operator graph from the training script, splitting the operator graph into first and second portions of a heterogeneous pipeline, tuning a first accelerator core for the first portion of the heterogeneous pipeline and a second accelerator core for the second portion of the heterogeneous pipeline, and generating a hardware architecture that includes the first accelerator core and the second accelerator core arranged to collectively accomplish the deep learning model.

Another example can include any of the above and/or below examples where the tuning comprises tuning for a single accelerator core type, tuning for two accelerator core types, or tuning for more than two accelerator core types.

Another example can include any of the above and/or below examples where the generating comprises generating a scheduling recommendation that co-optimizes scheduling of the operator graph with the hardware architecture across an entire training pipeline defined by the operator graph.

1. A system, comprising:
a graph generator module configured to obtain multiple user deep learning (DL) workloads and graph the DL workloads to operators;
a local architecture search module configured to receive an architectural template that relates to accelerator core types and evaluate individual accelerator types at accomplishing sub-sets of the operators; and,
a global architecture search module configured to evaluate combinations of accelerators of the accelerator types for collectively accomplishing the operators and generate a ranking of accelerator hardware architectures that employs an individual evaluated combination of accelerators for performing the workload.

2. The system of claim 1, wherein the graph generator module comprises an operator graph generator sub-module that is configured to extract the graph from a training script of the DL workload.

3. The system of claim 2, wherein the operator graph generator sub-module is configured to map the operators to accelerator core types.

4. The system of claim 3, wherein the graph generator module comprises a model splitter sub-module that is configured to partition DL models of the DL workload across accelerators.

5. The system of claim 4, wherein the graph generator module comprises a model splitter sub-module that is configured to perform operator graph optimizations that consider a memory hierarchy of the accelerators.

6. The system of claim 5, wherein the local architecture search module comprises an architecture estimator sub-module that is configured to annotate latency estimations associated with execution of individual graph operators and to determine power usage of potential architectures defined by the architectural template.

7. The system of claim 6, wherein the local architecture search module comprises a critical path analyzer sub-module that is configured to identify critical operators and determine latencies of the operators.

8. The system of claim 7, wherein the local architecture search module comprises an architecture search sub-module that is configured to perform a local search to determine a design of a single accelerator.

9. The system of claim 8, wherein the local architecture search module comprises a convergence checker sub-module that is configured to track relative performance of hardware architectures identified by the global architecture search module.

10. The system of claim 9, wherein the local architecture search module comprises an architecture configuration generator sub-module that is configured to annotate each operator in the graph with the type of core the operator executed on, latency to execute on the core, and energy expended during the execution.

11. The system of claim 10, wherein the global architecture search module comprises a global architecture optimizer that is configured to receive a set of architectural designs and identify splits in the designs associated with accelerator latency bottlenecks.

12. A system, comprising:
storage configured to store computer-readable instructions; and
a processor configured to execute the computer-readable instructions to:
obtain a deep learning (DL) model for accomplishing a workload;
receive an architectural template that relates to multiple accelerator cores types;
generate a graph of operators for the DL model;
identify a first portion of the graph of operators to perform with an accelerator core of a first accelerator core type and a second portion of the graph of operators to perform with a second accelerator core of a second accelerator core type; and,
generate a recommended hardware architecture for an accelerator that includes the first accelerator core and the second accelerator core.

13. The system of claim 12, wherein the workload comprises a training script for the DL model and wherein the architectural template defines areas of each core type and available chip area.

14. The system of claim 12, wherein the identifying comprises performing compiler optimizations on the graph.

15. The system of claim 14, wherein the identifying further comprises generating parallelization schemes for training the DL model.

16. The system of claim 15, wherein the generating recommended accelerator hardware architecture further comprises generating scheduling recommendations for the recommended accelerator hardware architecture.

17. The system of claim 12, wherein the generating recommended accelerator hardware architecture comprises generating recommended hardware architecture and their corresponding schedule accelerator in a pipelined distributed training-based execution.

18. A device-implemented method, comprising:
obtaining a deep learning training script associated with a deep learning model;
extracting an operator graph from the training script;
splitting the operator graph into first and second portions of a heterogeneous pipeline;
tuning a first accelerator core for the first portion of the heterogeneous pipeline and a second accelerator core for the second portion of the heterogeneous pipeline; and,
generating a hardware architecture that includes the first accelerator core and the second accelerator core arranged to collectively accomplish the deep learning model.

19. The method of claim 18, wherein the tuning comprises tuning for a single accelerator core type, tuning for two accelerator core types, or tuning for more than two accelerator core types.

20. The method of claim 19, wherein the generating comprises generating a scheduling recommendation that co-optimizes scheduling of the operator graph with the hardware architecture across an entire training pipeline defined by the operator graph.
